(19) United States
(12) Patent Application Publication
(10) Pub. No.: US 2008/0250571 A1
(43) Pub. Date: Oct. 16, 2008

(54) Method for Treating Surfaces

(75) Inventors: Oihana Elizalde, Mannheim (DE); Michael Schmitt, Worms (DE); Marc Bothe, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/066,583

(22) PCT Filed: Sep. 11, 2006
(86) PCT No.: PCT/EP06/66232

§ 371 Date: Mar. 12, 2008

(30) Foreign Application Priority Data
Sep. 16, 2005 (DE) 10 2005 044 520.9

(51) Int. Cl. D06M 15/00; C09D 5/00

(52) U.S. Cl. 8/115.51; 524/500; 524/81

(57) ABSTRACT

A process for treating a surface comprises said surface being treated with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
   and subsequently dried.

The present invention relates to a process for treating a surface, which comprises said surface being treated with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
   and subsequently dried.

The present invention further relates to treated surfaces. The present invention further relates to preferably aqueous formulations and a process for producing preferably aqueous formulations which are in accordance with the present invention.

For some years there has been appreciable interest in treating surfaces such that they are soil repellent or at least difficult to soil. Various methods involve providing the surfaces with texturing, for example with elevations 5 to 100 μm high and 5 to 200 μm spaced apart. A surface has been endowed with texturing that seeks to emulate the lotus plant, see for example WO 96/04123 and U.S. Pat. No. 3,354,022. However, such an approach is not always advisable and unsuitable for treating textile surfaces.

EP 1 283 296 discloses coating textile sheetlike constructions with a coating prepared by coating them with 50% to 80% by weight of at least one finely divided material selected from for example potato starch and oxidic materials such as for example silica gel, quartz flour or kaolin, having diameters in the range from 0.5 to 100 μm (at least 80% by weight of the finely divided material), 20% to 50% by weight of a matrix comprising a binder, a fluorinated polymer and if appropriate auxiliaries.

WO 04/74568 discloses a process for finishing textile materials by treatment with at least one aqueous liquor comprising at least one organic polymer and at least one organic or inorganic solid in particulate form, the organic or inorganic solid or solids being present in the liquor in a fraction of at least 5.5 g/l. Silica gel, in particular pyrogenic silica gel, is preferred as solid in particulate form.

Potato starch, as recommended in EP 1 283 296, however, has a certain solubility in aqueous liquors which varies with the temperature, so that the diameter of the potato starch particles cannot be optimally controlled during a coating operation. Especially in the case of inorganic solids such as silica gel for example, a certain propensity to agglomerate is observed, which is disadvantageous at application and makes placing of the textural parameters more difficult.

It is further observed that there are many cases where such textiles, coated by the aforementioned methods, possess insufficient washability at times. If, for example, sweaty textiles are washed, it is to be observed that the soil-repellent effect is reduced after the first wash and has virtually disappeared after several wash cycles.

The present invention has for its object to provide a process for treating surfaces which avoids the abovementioned disadvantages, in particular with regard to the treatment of textile surfaces. The present invention further has for its object to provide treated surfaces which avoid the abovementioned disadvantages and exhibit good soil repellency.

We have found that this object is achieved by the process defined at the beginning.

The process of the invention is directed to surfaces. Surfaces for the purposes of the present invention may consist of any desired material and belong to any desired article. Preference is given to surfaces composed of fibrous materials such as for example paper, board, leather, artificial leather, Alcantara, and more particularly surfaces are surfaces of textiles.

Textiles for the purposes of the present invention are textile fibers, textile intermediate and end products and finished articles manufactured therefrom which, as well as textiles for the apparel industry, also comprise for example carpets and other home textiles and also textile constructions for industrial purposes. These include unshaped constructions such as for example staples, linear constructions such as twine, filaments, yarns, lines, strings, laces, braids, cordage and also three-dimensional constructions such as for example felts, wovens, nonwovens and waddings. Textiles for the purposes of the present invention can be of natural origin, examples being cotton, wool or flax, or synthetic, examples being polyamide, polyester, modified polyester, polyester blend fabrics, polyamide blend fabrics, polyacrylonitrile, triacetate, acetate, polycarbonate, polypropylene, polyvinyl chloride, polyester microfibers and glass fiber fabrics. Textiles composed of cotton are particularly preferred.

For the purposes of the present invention, textile sheetlike constructions may have one surface (side, face) treated by the process of the present invention and the other not, or both surfaces (sides, faces) may be treated by the process of the present invention. For example, there are some garments such as workwear for example where it may be sensible to treat the outer surface by the process of the present invention and the inside (body-facing) surface not; and it may be sensible on the other hand for both sides (front and back) of some industrial textiles such as awnings for example to be treated by the process of the present invention.

The treating in accordance with the present invention is with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers.

One embodiment of the present invention comprises selecting hydrophobicizing agents from
(a1) halous organic (co)polymers,
(a2) paraffins, and
(a3) compounds having at least one C₁₀-C₆₀-alkyl group per molecule.

Useful halous organic (co)polymers (a1) include for example chlorinated and especially fluorinated (co)polymers preparable by preferably free-radical (co)polymerization of one or more mono- or poly-halogenated, preferably chlorinated and more preferably -fluorinated, (co)monomers.

Very particularly preferred halogenated (co)monomers are fluorous olefins such as for example vinylidene fluoride, trifluorochloroethylene, tetrafluoroethylene, hexafluoropropylene, vinyl esters of fluorinated or perfluorinated C₃-C₁₁-carboxylic acids as described for example in U.S. Pat. No. 2,592,069 and U.S. Pat. No. 2,732,370, (meth)acrylic esters of fluorinated or perfluorinated alcohols such as for example fluorinated or perfluorinated C₃-C₁₄-alkyl alcohols, for example (meth)acrylic esters of HO—CH₂—CH₂—CF₃, HO—CH₂—CH₂—C₂F₅, HO—CH₂—CH₂-n-C₃F₇, HO—CH₂HO—CH₂—CH₂-n-C₄F₉, HO—CH₂—CH₂-n-C₆F₁₃, HO—CH₂—CH₂-n-C₈F₁₇, HO—CH₂—CH₂-O-n-C₆F₁₃, HO—CH₂—CH₂—O-n-C₈F₁₇, HO—CH₂—CH₂-n-C₁₀F₂₁, HO—CH₂—CH₂-n-C₁₂F₂₅, described for example in U.S. Pat. No. 2,642,416, U.S. Pat. No. 3,239,557 and U.S. Pat. No. 3,462,296.

Copolymers of for example (meth)acrylic acid and/or C₁-C₂₀-alkyl esters of (meth)acrylic acid or glycidyl(meth)acrylate with esters of the formula I

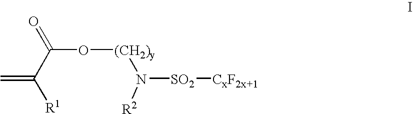

where
R¹ is hydrogen, CH₃, C₂H₅,
R² is CH₃, C₂H₅,
x is an integer in the range from 4 to 12, preferably 6 to 8,
y is an integer in the range from 1 to 11, preferably 1 to 6,

or glycidyl(meth)acrylate with vinyl esters of fluorinated carboxylic acids are also useful as halous organic (co)polymers (a).

Useful halous organic (co)polymers (a) further include copolymers of (meth)acrylic esters of fluorinated, especially perfluorinated, C₃-C₁₂-alkyl alcohols such as for example HO—CH₂—CH₂—CF₃, HO—CH₂—CH₂-C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₆F₁₃, HO—CH₂—CH₂-n-C₈F₁₇, HO—CH₂—CH₂—O-n-C₆F₁₃, HO—CH₂—CH₂—O-n-C₈F₁₇, HO—CH₂—CH₂-n-C₁₀F₂₁, HO—CH₂—CH₂-n-C₁₂F₂₅, with (meth)acrylic esters of nonhalogenated C₁-C₂₀-alcohols, for example methyl(meth)acrylate, ethyl(meth)acrylate, n-butyl(meth)acrylate, n-propyl(meth)acrylate, 2-ethylhexyl(meth)acrylate, n-octyl(meth)acrylate, n-decyl(meth)acrylate, n-dodecyl(meth)acrylate, n-eicosyl(meth)acrylate.

An overview of fluorinated polymers and copolymers useful as halous organic (co)polymers (a1) is to be found for example in M. Lewin et al., Chemical Processing of Fibers and Fabrics, Part B, volume 2, Marcel Dekker, New York (1984), pages 172 ff. and pages 178-182.

Further fluorinated (co)polymers useful as halous organic (co)polymers (a1) are described for example in DE 199 120 810.

The process of the present invention may be carried out using one halous (co)polymer (a1) or a plurality of different halous (co)polymers (a1).

Halous (co)polymer (a1) is preferably used in uncrosslinked form to carry out the process of the present invention, but it may crosslink during drying.

Other suitable hydrophobicizing agents (a) are paraffins (a2). Paraffins (a2) may be for example liquid or solid at room temperature and of natural or preferably synthetic origin. Preferred paraffins (a2) are synthetic paraffins such as for example Fischer-Tropsch waxes, high density polyethylene waxes, prepared using Ziegler-Natta catalysts or metallocene catalysts for example, also partially oxidized high density polyethylene waxes having an acid number in the range from 1 to 150 mg KOH/g of paraffin, determined according to DIN 53402, with high density polyethylene waxes comprising not just homopolymer waxes of ethylene, but also copolymers of polyethylene with in total up to 20% by weight of comonomer such as propylene, 1-butene, 1-pentene, 1-hexene, 1-octene, 1-decene or 1-dodecene, especially so-called paraffin waxes and isoparaffin waxes, for example crude paraffins (crude paraffin waxes), slack wax raffinates, deoiled crude paraffins (deoiled crude paraffin waxes), semi- or fully refined paraffins (semi- or fully refined paraffin waxes) and bleached paraffins (bleached paraffin waxes). By paraffin waxes are herein meant in particular room temperature solid paraffins melting in the range from 40 to 80° C., and preferably in the range from 50 to 75° C., i.e. saturated hydrocarbons, branched or unbranched, cyclic or preferably acyclic, individually or preferably as a mixture of a plurality of saturated hydrocarbons. Paraffin waxes in the context of the present invention are preferably composed of saturated hydrocarbons having 18 to 45 carbon atoms. Isoparaffins in the context of the present invention are preferably composed of saturated hydrocarbons having 20 to 60 carbon atoms per molecule.

Useful hydrophobicizing agents (a) further include linear or heterocyclic, preferably heteroaromatic compounds having at least one C₁₀-C₆₀-alkyl group, preferably having a C₁₂-C₄₀-alkyl group per molecule (a3), hereinafter also abbreviated to compound (a3), the C₁₀-C₆₀-alkyl groups being different or preferably the same and branched or preferably unbranched. Preference is given to such compounds (a3) as are able to detach at least one fatty amine or at least one fatty alcohol on heating to temperatures in the range from 120 to 200° C., i.e. to an amine or an alcohol having a C₁₀-C₆₀-alkyl group.

Very particular preference is given to compounds of the general formula II

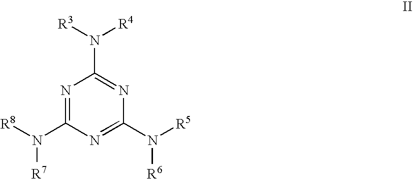

where
R³ is selected from C₁₀-C₆₀-alkyl, branched or preferably unbranched, for example n-C₁₀H₂₁, n-C₁₂H₂₅, n-C₁₄H₂₉, n-C₁₆H₃₃, n-C₁₈H₃₇, n-C₂₀H₄₁, n-C₃₀H₆₁, n-C₄₀H₈₁, n-C₅₀H₁₀₁, n-C₆₀H₁₂₁, and R⁹—OCH₂, where R⁹ is selected C₁₀-C₆₀-alkyl, branched or preferably unbranched, for example n-C₁₀H₂₁, n-C₁₂H₂₅, n-C₁₄H₂₉, n-C₁₆H₃₃, n-C₁₈H₃₇, n-C₂₀H₄₁, n-C₃₀H₆₁, n-C₄₀H₈₁, n-C₅₀H₁₀₁, n-C₆₀H₁₂₁. Carbon numbers and corresponding hydrogen numbers are to be considered averages.
R⁴ to R⁸ are different or preferably the same and are selected from hydrogen, R³, CH₂—OH, CH₂—O—C₁-C₁₀-alkyl, especially CH₂—OCH₃, CH₂—OC₂H₅, CH₂—O-n-C₄H₉, CH₂—OCH₂CH₂OH, CH₂—OCH₂CH₂O—C₁-C₁₀-alkyl, especially CH₂—OCH₂CH₂OCH₃, CH₂—OCH₂CH₂OC₂H₅, CH₂—OCH₂CH₂O-n-C₄H₉, CH₂—(OCH₂CH₂)₂O—H, CH₂—(OCH₂CH₂)₂O—C₁-C₁₀-alkyl, especially CH₂—(OCH₂CH₂)₂OCH₃, CH₂—(OCH₂CH₂)₂OC₂H₅, and CH₂—(OCH₂CH₂)₂O-n-C₄H₉.

Further particularly preferred examples of compounds (a3) are compounds of the general formula III

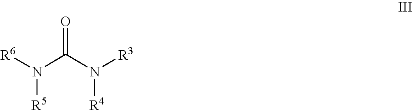

where the variables are each as defined above.

One embodiment of the present invention utilizes a hydrophobicizing agent (a) comprising a combination of at least one paraffin (a2) and at least one compound (a3).

Useful crosslinked organic copolymers in particulate form (b) are halous and preferably halogen-free copolymers obtainable by free-radical copolymerization of at least one monoethylenically unsaturated comonomer and at least one at least diethylenically unsaturated comonomer (crosslinker) and which are in particulate form.

Examples of monoethylenically unsaturated comonomers useful for preparing crosslinked organic copolymers in particulate form (b) are monovinylaromatics, for example α-methylstyrene and especially styrene, and C₁-C₁₀-alkyl esters of ethylenically unsaturated carboxylic acids such as for example acrylic acid or methacrylic acid, more particularly methyl acrylate, ethyl acrylate, n-butyl acrylate, t-butyl acrylate, ethylhexyl acrylate, n-butyl methacrylate, t-butyl methacrylate and methyl methacrylate. Acrylonitrile may also be used.

Useful crosslinkers include for example di- and trivinylaromatics, for example orth divinylbenzene, meta-divinylbenzene and paradivinylbenzene, also ethylenically unsaturated carboxylic acids esterified with ethylenically unsaturated alcohol, examples being allyl (meth)acrylate, and also (meth)acrylates of di- or trihydric alcohols, examples being ethylene glycol di(meth)acrylate, 1,3-propanediol di(meth)acrylate, diethylene glycol di(meth)acrylate, 1,4-butanediol di(meth)acrylate, 1,6-hexanediol di(meth)acrylate, 1,1,1-trimethylolpropane di(meth)acrylate, 1,1,1-trimethylolpropane tri(meth)acrylate.

Crosslinked organic copolymers in particulate form (b) may be prepared by using for example up to 20 mol %, preferably from 1 to 10 mol % and more preferably at least 3 mol % of crosslinker with at least 80 mol %, preferably at least 90 mol % and more preferably up to 97 mol % of one or more aforementioned monoethylenically unsaturated comonomers.

Crosslinked organic copolymer in particulate form (b) is obtainable by comminuting the copolymer by suitable methods of particle formation, for example by grinding, after the actual synthesis. The synthesis may also be carried out such that copolymer of monoethylenically unsaturated comonomer or monounsaturated comonomers and crosslinker is generated in particulate form, for example by conducting the synthesis in the form of an emulsion polymerization or else as a polymerization in miniemulsion, or as a suspension polymerization.

Particulate form in the context of the present invention is to be understood as meaning that crosslinked copolymer (b) is present in the form of particles which are not dissolved in water or aqueous medium. The particles in question may have an irregular shape or may preferably have a regular shape, for example an ellipsoidal or spherical shape, this to be understood as comprising such particles where at least 75% by weight and preferably at least 90% by weight are present in spherical form and further particles may be present in granular form.

One embodiment of the present invention comprises crosslinked organic copolymer in particulate form (b) being present neither in the form of aggregates nor in the form of agglomerates.

One embodiment of the present invention comprises crosslinked organic copolymer in particulate form (b) having a weight average diameter in the range from 10 to 450 nm, preferably in the range from 20 to 250 nm and more preferably in the range from 50 to 100 nm. Particle diameter may be measured using common methods such as transmission electron microscopy for example.

One embodiment of the present invention comprises crosslinked organic copolymer in particulate form (b) having a homogeneous distribution of particle sizes, i.e., at least 80% by weight of the particles have a diameter in the range from ±20% of the average diameter.

Another embodiment of the present invention comprises crosslinked organic copolymer in particulate form (b) having a bimodal or multimodal distribution of particle sizes.

One embodiment of the present invention comprises crosslinked organic copolymer in particulate form (b) having a certain thermal dimensional stability in that crosslinked organic copolymer in particulate form (b) stored at 30 to 200° C., preferably from 120 to 180° C. and more preferably 150 to 170° C. does not change its dimensions to any measurable extent for a period in the range from 1 second to 30 minutes and preferably up to 3 minutes.

Useful film-forming addition copolymer having epoxy groups, NH—CH₂OH groups or acetoacetyl groups (c) includes for example copolymers of one or more monoethylenically unsaturated comonomers such as for example monovinylaromatics, monoethylenically unsaturated carboxylic acids, C₁-C₁₀-alkyl esters of monoethylenically unsaturated carboxylic acids, monoethylenically unsaturated carboxamides, polyfunctional derivatives of ethylenically unsaturated carboxylic acids, with one or more comonomers having epoxy groups, NH—CH₂OH groups or acetoacetyl groups.

Examples of particularly suitable monovinylaromatics are a-methylstyrene, para-methylstyrene, 2,4-dimethylstyrene and especially styrene.

Particularly suitable monoethylenically unsaturated carboxylic acids are for example maleic acid, fumaric acid, E- and Z-crotonic acids, itaconic acid and especially acrylic acid and methacrylic acid.

Particularly suitable C₁-C₁₀-alkyl esters of monoethylenically unsaturated carboxylic acids are esters of branched or unbranched C₁-C₁₀-alkanol with one of the aforementioned monoethylenically unsaturated carboxylic acids. Specific examples are: methyl acrylate, methyl methacrylate, ethyl acrylate, ethyl methacrylate, n-butyl acrylate, n-butyl methacrylate, tert-butyl acrylate, 2-ethylhexyl acrylate, 2-ethylhexyl methacrylate.

Particularly suitable monoethylenically unsaturated carboxamides are N-methylacrylamide, N-methylmethacrylamide, N-ethylacrylamide, N-ethylmethacrylamide, N,N-dimethylacrylamide, N,N-dimethylmethacrylamide and especially acrylamide and methacrylamide.

Particularly suitable polyfunctional derivatives of ethylenically unsaturated carboxylic acids are compounds of the general formula IV

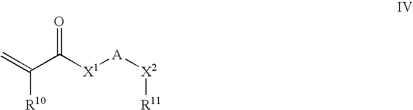

where
X¹ and X² are the same or different and selected from oxygen, NH and N—R¹¹,
A is a spacer, for example branched or unbranched C₂-C₂₀-alkylene or phenylene. Examples of C₂-C₂₀-alkylene are —(CH₂)₂—, —CH₂—CH(CH₃)—, —(CH₂)₃—, —CH₂—CH(C₂H₅)—, —(CH₂)₄—, —(CH₂)₅—, —(CH₂)₆—, —(CH₂)₇—, —(CH₂)₈—, —(CH₂)₉—, —(CH₂)₁₀—; preferably C₂-C₄-alkylene; especially —(CH₂)₂—, —CH₂—CH(CH₃)—, —(CH₂)₃—, —(CH₂)₄— and —CH₂—CH(C₂H₅)—.
R¹⁰ and R¹¹ are the same or different and selected from C₁-C₁₀-alkyl, for example methyl, ethyl, n-propyl, iso-propyl, n-butyl, iso-butyl, sec-butyl, tert-butyl, n-pentyl, iso-pentyl, sec-pentyl, neopentyl, 1,2-dimethylpropyl, iso-amyl, n-hexyl, iso-hexyl, sec-hexyl, n-heptyl, n-octyl, 2-ethylhexyl, n-nonyl, n-decyl, more preferably unbranched C₁-C₄-alkyl such as methyl, ethyl, n-propyl and n-butyl.

Particularly suitable comonomers having epoxy groups are for example glycidyl esters of maleic acid, fumaric acid, E- and Z-crotonic acids and especially of acrylic acid and of methacrylic acid.

Particularly suitable comonomers having NH—CH₂OH groups are for example reaction products of formaldehyde with monoethylenically unsaturated carboxamides, especially N-methylolacrylamide and N-methylolmethacrylamide.

Particularly suitable comonomers having acetoacetyl groups are for example (meth)acrylates of alcohols of the general formula V

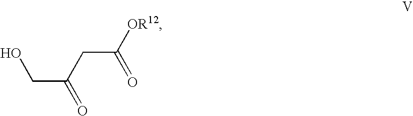

where
R¹² is selected from branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neopentyl, 1,2-dimethylpropyl, iso-amyl, n-hexyl, iso-hexyl, sec-hexyl, n-heptyl, n-octyl, 2-ethylhexyl, n-nonyl, n-decyl, more preferably unbranched C₁-C₄-alkyl such as methyl, ethyl, n-propyl and n-butyl.

Film-forming addition copolymers having epoxy groups, NH—CH₂OH groups or acetoacetyl groups (c) are preparable in a conventional manner, for example by emulsion polymerization with one or more free-radical starters in the presence of one or more emulsifiers. Particular preference is given to preparing film-forming copolymers having epoxy groups, NH—CH₂OH groups or acetoacetyl groups (c) by an emulsion polymerization in seeded mode; that is, initially one or more water-insoluble polymers such as for example polystyrene are added in very small particles, for example having an average diameter in the range from 15 to 30 nm, which then promote droplet formation during the copolymerization. The polymers which are added in very small particles at the start of the copolymerization are not to be confused with crosslinked organic copolymer in particulate form (b).

One embodiment of the present invention comprises film-forming addition copolymer having epoxy groups, NH—CH₂OH groups or acetoacetyl groups (c) having a room temperature viscosity in the range from 10 to 200 mPa·s, determined by Brookfield for example.

One embodiment of the present invention comprises film-forming addition copolymer having epoxy groups, NH—CH₂OH groups or acetoacetyl groups (c) having a glass transition temperature T_{g} in the range from −50 to +30° C. and preferably in the range from −20 to +30° C.

One embodiment of the present invention comprises film-forming addition copolymer having epoxy groups, NH—CH₂OH groups or acetoacetyl groups (c) having from 0.1% to 7% by weight of an interpolymerized comonomer having for example one epoxy group, NH—CH₂OH group or acetoacetyl group per molecule.

One specific embodiment of the present invention further comprises treating with at least one emulsifier (d). Useful emulsifiers (d) are anionic, cationic and nonionic surface-active compounds.

Suitable nonionic surface-active compounds are for example ethoxylated mono-, di- and trialkylphenols (degree of ethoxylation in the range from 3 to 50, alkyl radical: C₄ to C₁₂) and also ethoxylated fatty alcohols (degree of ethoxylation in the range from 3 to 80; alkyl radical: C₈ to C₃₆). Examples are the Lutensol® brands of BASF Aktiengesellschaft or the Triton® brands of Union Carbide. Further suitable nonionic surface-active compounds are those of the general formula VI

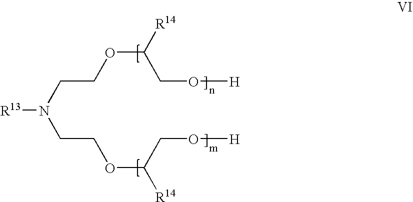

R¹³ selected from C₆-C₄₀-alkyl, for example n-hexyl, iso-hexyl, n-heptyl, iso-heptyl, n-octyl, iso-octyl, n-nonyl, n-decyl, iso-decyl, n-undecyl, n-dodecyl, iso-dodecyl, n-tridecyl, n-tetradecyl, iso-tetradecyl, n-pentadecyl, n-hexadecyl, n-octadecyl, n-eicosyl, n-C₃₀H₆₁, n-C₄₀H₈₁,
C₃-C₄₀-alkenyl having one to five C—C double bonds, the C—C double bonds being isolated or conjugated for example. Specific examples are allyl, —(CH₂)₂—CH═CH₂, all-cis-(CH₂)₈—(CH═CH—CH₂)₃CH₃, all-cis-(CH₂)₈—(CH═CH—CH₂)₂(CH₂)₄CH₃, cis-(CH₂)₈—CH═CH—(CH₂)₇CH₃,
R¹⁴ the same or different and selected from hydrogen and methyl, preferably hydrogen,
m and n the same or different and selected from integers in the range from 0 to 20 and preferably in the range from 2 to 12.

Suitable anionic surface-active compounds are for example alkali metal and ammonium salts of alkyl sulfates (alkyl radical: C₈ to C₁₂), of sulfuric monoesters of ethoxylated alkanols (degree of ethoxylation in the range from 4 to 30, alkyl radical: C₁₂ to C₁₈) and of ethoxylated alkylphenols (degree of ethoxylation in the range from 3 to 50, alkyl radical: C₄ to C₁₂), of alkylsulfonic acids (alkyl radical: C₁₂-C₁₈) and of alkylarylsulfonic acids (alkyl radical: C₉ to C₁₈). Specific suitable anionic surface-active compounds are alkali metal and ammonium salts of sulfitized C₅-C₄₀-alkyl monoesters of succinic acid.

Suitable cationic surface-active compounds are generally C₆-C₁₈-alkyl-, C₆-C₁₈-aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic acid esters, N-cetylpyridinium chloride, N-laurylpyridinium sulfate, A-cetyl-N,N,N-trimethylammonium bromide, A-dodecyl-N,N,N-trimethylammonium bromide, N,N-distearyl-N,N-dimethylammonium chloride and also the Gemini surfactant N,N-(lauryldimethyl)ethylenediamine dibromide. Numerous further examples may be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

The surface to be treated may be treated in one or more steps with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers.

The process of the present invention may be carried out for example by the surface to be treated being treated with at least one preferably aqueous formulation comprising
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers.

It is also possible to perform a plurality of treating steps using identical or different preferably aqueous formulations.

Aqueous formulations may be any desired aqueous suspensions and preferably are aqueous liquors.

Aqueous formulations and especially aqueous liquors may have a solids content in the range from 10% to 70% by weight and preferably in the range from 30% to 50% by weight.

One embodiment of the present invention comprises conducting the process of the present invention by treating the surface to be treated by initially treating it with a preferably aqueous formulation comprising at least one hydrophobicizing agent (a) and further one crosslinked organic copolymer in particulate form (b) and subsequently with a new liquor comprising at least one film-forming addition copolymer having epoxy groups,

NH—CH₂OH groups or acetoacetyl groups (c) but no crosslinked organic copolymer in particulate form (b).

Another embodiment of the present invention comprises conducting the process of the present invention by treating the surface to be treated by initially treating it with a preferably aqueous formulation comprising at least one hydrophobicizing agent (a) and further at least one crosslinked organic copolymer in particulate form (b) and subsequently with a new preferably aqueous formulation comprising a different hydrophobicizing agent (a) and one film-forming addition copolymer having epoxy groups,

NH—CH₂OH groups or acetoacetyl groups (c) but no crosslinked organic copolymer in particulate form (b).

Another embodiment of the present invention comprises conducting the process of the present invention by treating the surface to be treated by initially treating it with a preferably aqueous formulation comprising at least one film-forming addition copolymer having epoxy groups, NH—CH₂OH groups or acetoacetyl groups (c) and further at least one crosslinked organic copolymer in particulate form (b) and subsequently with a new preferably aqueous formulation comprising a hydrophobicizing agent (a).

Another embodiment of the present invention comprises conducting the process of the present invention by treating the surface to be treated by initially treating it with a preferably aqueous liquor comprising at least one hydrophobicizing agent (a), at least one crosslinked organic copolymer in particulate form (b) and a film-forming addition copolymer having epoxy groups, NH—CH₂OH groups or acetoacetyl groups (c) and subsequently with a new liquor comprising neither hydrophobicizing agent (a) nor film-forming addition copolymer having epoxy groups, NH—CH₂OH groups or acetoacetyl groups (c), but the crosslinked organic copolymer in particulate form (b) already used in the first step.

The temperature for practicing the treatment of the present invention is in itself not critical. The temperature may be in the range from 10 to 60° C. and preferably in the range from 15 to 30° C.

Preferably aqueous formulation and especially preferably aqueous liquor may have a pH in the range from 2 to 9 and preferably in the range from 3.5 to 7.5.

To practice the process of the present invention by treating the surface to be treated with an aqueous liquor, the wet pickup may be chosen such that the process of the present invention results in a wet pickup in the range from 25% by weight to 95% by weight and preferably in the range from 60% to 90% by weight.

The process of the present invention is in one embodiment of the present invention carried out in common machines used for the finishing of textiles, for example pad-mangles. Preference is given to vertical textile feed pad-mangles, where the essential element is two rollers in press contact with each other, through which the textile is led. Preferably aqueous formulation is filled in above the rollers and wets the textile. The pressure causes the textile to be squeezed off and ensures a constant add-on. In other preferred pad-mangles, textile is first led through a dip bath and then upwardly through two rollers in pressed contact with each other. In the latter case, the pad-mangles are also said to have a vertically upward textile feed. Pad-mangles are described for example in Hans-Karl Rouette, “Handbuch der Textilveredlung”, Deutscher Fachverlag 2003, pages 618 to 620.

In another embodiment of the present invention, the surface to be treated is contacted with an aqueous formulation comprising
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers.

Contacting in accordance with the present invention may be accomplished for example by single or multiple spraying, drizzling, overpouring or printing.

Aqueous formulations for the purposes of the present invention may comprise one or more organic solvents, for example alcohols such as methanol, ethanol, isopropanol, ethylene glycol, diethylene glycol, triethylene glycol, acetone, methyl ethyl ketone, methyl isobutyl ketone, ethylene glycol mono-n-butyl ether, ethylene glycol monoisobutyl ether, acetic acid, n-butanol, isobutanol, n-hexanol and isomers, n-octanol and isomers, n-dodecanol and isomers. Organic solvents may comprise from 1% to 40% by weight and preferably from 2% to 25% by weight of the continuous phase of aqueous formulation used in accordance with the present invention. Aqueous formulations is to be understood as referring to such formulations where the continuous phase consists predominantly or, at the extreme, exclusively of water.

The treated surface is dried after the treatment of the present invention. Drying may be accomplished for example at temperatures in the range from 20 to 120° C.

Drying may be carried out at atmospheric pressure for example. It may also be carried out at reduced pressure, for example at a pressure in the range from 1 to 850 mbar.

Drying may utilize a heated or unheated stream of gas, in particular a heated or unheated stream of an inert gas such as nitrogen for example. To utilize a heated stream of gas, suitable temperatures range for example from 30 to 200° C., preferably from 120 to 180° C. and more preferably from 150 to 170° C.

The treatment of the present invention and the drying operation may be followed by a thermal treatment, also referred to as tempering in the context of the present invention, as a continuous operation or as a batch operation. The duration of the tempering treatment can be chosen within wide limits. The tempering treatment can typically be carried out for a duration in the range from about 1 second to 30 minutes and especially up to 3 minutes. A tempering treatment is carried out by heating to temperatures of up to 180° C., preferably in the range from 150 to 170° C. It is of course necessary to adapt the temperature of the tempering treatment to the sensitivity of the material of which the surface is made that has been treated according to the present invention.

Hot air drying is an example of a specific suitable method of tempering.

A specific embodiment of the present invention comprises treating surfaces with a preferably aqueous formulation comprising
(a) from 0.1% to 20% by weight and preferably from 1% to 15% by weight of hydrophobicizing agent,
(b) from 1% to 25% by weight and preferably from 5% to 15% by weight of crosslinked organic copolymer in particulate form,
(c) from 1% to 25% by weight and preferably from 2% to 20% by weight of film-forming addition copolymer having epoxy groups, NH—CH₂OH groups or acetoacetyl groups,
(d) from 0% to 10% by weight and preferably from 0.01% to 5% by weight of emulsifier,
(e) in total from 0% to 50% by weight and preferably from 1% to 25% by weight of auxiliaries,
   all weight %ages being based on entire preferably aqueous formulation.

One embodiment of the present invention comprises practicing the process of the present invention by utilizing an aqueous formulation further comprising one or more auxiliaries (e), for example up to 50% by weight, based on the entire preferably aqueous formulation. Especially when one or more textile surfaces are to be treated, it may be advantageous to include one or more auxiliaries (e) in preferably aqueous formulation utilized for the purposes of the present invention, in which case auxiliaries (e) are selected from biocides, thickeners, foam inhibitors, wetting agents, plasticizers, hand modifiers (hand-modifying agents), fillers, crosslinkers (hardeners) and film-forming assistants.

An example of a biocide useful as an auxiliary (e) is 1,2-benzisothiazolin-3-one (BIT) (commercially available as Proxel® brands from Avecia Lim.) and its alkali metal salts; other suitable biocides are 2-methyl-2H-isothiazole-3 (MIT) and 5-chloro-2-methyl-2H-isothiazol-3-one (CIT). In general, from 10 to 150 ppm of biocide will be sufficient, based on preferably aqueous formulation.

Useful auxiliaries (e) further include one or more thickeners, which may be of natural or synthetic origin. Suitable synthetic thickeners are poly(meth)acrylic compounds, polycarboxylic acids, polyethers, polyimines, polyamides and polyurethanes, especially copolymers comprising 85% to 95% by weight of acrylic acid, 4% to 15% by weight of acrylamide and about 0.01% to 1% by weight of the (meth)acrylamide derivative of the formula VII

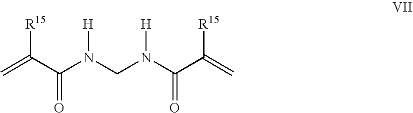

having molecular weights Mw in the range from 100 000 to 200 000 g/mol, in each of which R¹⁵ is methyl or preferably hydrogen. Examples of thickeners of natural origin are agar-agar, carrageen, modified starch and modified cellulose.

The amount of thickener included may be for example in the range from 0% to 10% by weight, preferably in the range from 0.05% to 5% by weight and more preferably in the range from 0.1% to 3% by weight, based on aqueous formulation used in the process of the present invention.

Examples of foam inhibitors useful as auxiliaries (e) are room temperature liquid silicones, nonethoxylated or singly or multiply ethoxylated.

Examples of wetting agents useful as auxiliaries (e) are alkyl polyglycosides, alkyl phosphonates, alkylphenyl phosphonates, alkyl phosphates and alkylphenyl phosphates.

Examples of plasticizers useful as auxiliaries (e) are ester compounds selected from the groups of the aliphatic or aromatic di- or polycarboxylic acids fully esterified with alkanols and of the at least singly alkanol-esterified phosphoric acid.

Alkanols are C₁-C₁₀-alkanols in one embodiment of the present invention.

Preferred examples of aromatic di- or polycarboxylic acids fully esterified with alkanol are fully alkanol-esterified phthalic acid, isophthalic acid and mellitic acid; specific examples are di-n-octyl phthalate, di-n-nonyl phthalate, di-n-decyl phthalate, di-n-octyl isophthalate, di-n-nonyl isophthalate, di-n-decyl isophthalate.

Preferred examples of aliphatic di- or polycarboxylic acids fully esterified with alkanol are for example dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, diisobutyl succinate and also mixtures thereof.

A preferred example of phosphoric acid at least monoesterfied with an alkanol are C₁-C₁₀-alkyl di-C₆-C₁₄-aryl phosphates such as isodecyl diphenyl phosphate.

Further suitable examples of plasticizers are aliphatic or aromatic di- or polyols at least monoesterified with C₁-C₁₀-alkylcarboxylic acid.

A preferred example of aliphatic or aromatic di- or polyols at least monoesterified with C₁-C₁₀-alkylcarboxylic acid is 2,2,4-trimethylpentane-1,3-diol monoisobutyrate.

Further suitable plasticizers are polyesters obtainable by polycondensation of aliphatic dicarboxylic acid and aliphatic diol, for example adipic acid or succinic acid and 1,2-propanediol, preferably having an M_{w} of 200 g/mol, and polypropylene glycol alkylphenyl ether, preferably having an M_{w} of 450 g/mol.

Further suitable plasticizers are polypropylene glycols etherified with two different alcohols and having a molecular weight M_{w} in the range from 400 to 800 g/mol, wherein preferably one of the alcohols may be an alkanol, especially a C₁-C₁₀-alkanol, and the other alcohol may preferably be an aromatic alcohol, for example o-cresol, m-cresol, p-cresol and especially phenol.

Examples of fillers useful as an auxiliary (e) are melamine and pigments in particulate form.

Examples of hand improvers useful as an auxiliary (e) are silicone emulsions, i.e., aqueous emulsions of silicones which may preferably bear hydrophilic groups such as for example OH groups or alkoxylate groups.

Examples of crosslinkers (hardeners) useful as an auxiliary (e) are condensation products of urea, glyoxal and formaldehyde, if appropriate etherified with preferably linear C₁-C₄-alkanol, especially doubly, triply or quadruply methanol- or ethanol-etherified

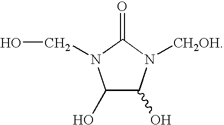

Crosslinkers (hardeners) useful as an auxiliary (e) further include isocyanurates and especially hydrophilicized isocyanurates and also mixed hydrophilicized diisocyanates/isocyanurates, for example the reaction product of C₁-C₄-alkyl polyethylene glycol with the isocyanurate of hexamethylene diisocyanate (HDI). Examples of suitable crosslinkers of this type are known from EP-A 0 486 881 for example.

Diethylene glycol is an example of a film-former (film-forming assistant) useful as an auxiliary (e).

In a further embodiment of the present invention, surface to be coated is provided with at least one primer (f) before the treatment with (a) to (c), if appropriate emulsifier (d) and if appropriate auxiliary or auxiliaries (e). Primer (f) preferably endows the surface which is to be treated in accordance with the present invention with a charge which is opposite to the charge of crosslinked organic copolymer in particulate form (b). When, for example, a cationic crosslinked organic copolymer in particulate form (b) is to be used, it is advantageous to use an anionic primer (f). When, however, an anionic crosslinked organic copolymer in particulate form (b) is to be used, it is advantageous to use a cationic primer (f).

Suitable primers (f) may be for example polymeric or nonpolymeric in nature. Suitable polymeric primers may for example have a number average molecular weight in the range from 5000 to 500 000 g/mol.

Useful cationic primers (f) include for example polyethyleneimine and especially aminosiloxanes such as for example siloxanes having at least one (CH₂)_{w}NH—R¹⁶ group in each of which w is an integer in the range from 1 to 10 and especially from 2 to 7 and R¹⁶ is selected from hydrogen, preferably linear C₁-C₄-alkyl and (CH₂)_{w}NH—R¹⁷, where R¹⁷ is selected from hydrogen and preferably linear C₁-C₄-alkyl, also polyvinylimidazole. Further suitable cationic primers (f) are polymers of diallyl di-C₁-C₄-alkylammonium halide, in each of which C₁-C₄-alkyl is preferably linear.

Further suitable cationic primers (f) are reaction products of equimolar amounts of preferably cyclic diamines with epichlorohydrin and an alkylating agent such as for example dimethyl sulfate, C₁-C₁₀-alkyl halide, especially methyl iodide, or benzyl halide, especially benzyl chloride. Such reaction products may have molecular weights M_{w} in the range from 1000 to 1 000 000 g/mol and are constructed as follows, illustrated with reference to the example of the reaction products of equimolar amounts of piperazine with epichlorohydrin and benzyl chloride:

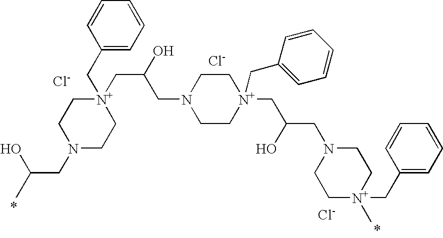

Suitable anionic primers (f) are for example homo- or copolymers of anionic monomers, especially of ethylenically unsaturated sulfonic acids, ethylenically unsaturated amine oxides or (meth)acrylic acid, if appropriate with one or more C₁-C₁₀-alkyl esters of (meth)acrylic acid. Further suitable anionic primers are for example anionic polyurethanes, i.e., herein such polyurethanes as comprise at least one sulfonic acid group or carboxylic acid group per molecule, preparable using 1,1-dimethylolpropionic acid for example.

To use one or more primers (f), it is preferable for it to be used in an aqueous formulation and to be applied prior to the treatment with crosslinked organic copolymer in particulate form (b). Suitable operating techniques include for example spraying, drizzling and especially padding.

The application of primer (f) and the treatment with crosslinked organic copolymer in particulate form (b) may be respectively followed and preceded by thermal treatment, the conditions of thermal treatment corresponding to the conditions described above.

One embodiment of the present invention comprises applying a cationic primer (f) to cotton surface, treating thermally if appropriate and subsequently treating with crosslinked organic copolymer in particulate form (b), emulsifier (c) and hydrophobicizing agent (a) and film-forming addition copolymer having epoxy groups, NH—CH₂OH groups or acetoacetyl groups (c). This is followed by thermal treatment.

Another embodiment of the present invention comprises applying an anionic primer (f) to polyester surface, treating thermally if appropriate and subsequently treating with crosslinked organic copolymer in particulate form (b), emulsifier (c) and hydrophobicizing agent (a) and film-forming addition copolymer having epoxy groups, NH—CH₂OH groups or acetoacetyl groups (c). This is followed by thermal treatment.

The present invention further provides surfaces coated with
(f) if appropriate at least one primer,
(a) at least one hydrophobicizing agent,
(b) at least one crosslinked organic copolymer in particulate form,
(c) at least one film-forming addition copolymer having epoxy groups, NH—CH₂OH groups or acetoacetyl groups.

Surfaces in accordance with the present invention can advantageously be produced by the above-described process of the present invention. Surfaces in accordance with the present invention are textured and repel water and have little tendency to soil.

One embodiment of the present invention comprises any emulsifier (d) or emulsifiers (d) used being applied only in traces, if at all, to surfaces of the present invention, and thus are essentially absent from the coated surfaces of the present invention.

One embodiment of the present invention comprises any auxiliary (e) or auxiliaries (e) used being applied only in traces, if at all, to surfaces of the present invention, and thus are essentially absent from the coated surfaces of the present invention.

In one embodiment of the present invention, surfaces of the present invention are characterized in that the treatment results in a coating which may be nonuniform or preferably uniform. Uniform is to be understood as meaning that the texturing is regular, while nonuniform means that the texturing is irregular, i.e., there are textured areas and nontextured areas on the surface.

In one embodiment of the present invention, surfaces of the present invention have a coating having an average add-on in the range from 1 to 10 g/m², preferably in the range from 1.5 to 5 g/m².

In one embodiment of the present invention, surfaces of the present invention are surfaces of textiles.

The present invention further provides aqueous formulations comprising
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
(e) if appropriate one or more auxiliaries.

In one embodiment of the present invention, preferably aqueous formulations of the present invention comprise
(a) from 0.1% to 20% by weight and preferably from 1% to 15% by weight of hydrophobicizing agent,
(b) from 1% to 25% by weight and preferably from 5% to 15% by weight of crosslinked organic copolymer in particulate form,
(c) from 1% to 25% by weight and preferably from 2% to 20% by weight of film-forming addition copolymer having epoxy groups, NH—CH₂OH groups or acetoacetyl groups,
(d) from 0% to 10% by weight and preferably from 0.01% to 5% by weight of emulsifier,
(e) in total from 0% to 50% by weight and preferably from 1% to 25% by weight of auxiliaries,

all weight %ages being based on entire preferably aqueous formulation of the present invention.

In one embodiment of the present invention, formulations in accordance with the present invention comprise one or more auxiliaries (e), preferably up to 10% by weight. In one embodiment of the present invention, preferably aqueous formulations in accordance with the present invention have a pH in the range from 2 to 9 and preferably in the range from 3.5 to 7.5.

In one embodiment of the present invention, preferably aqueous formulations in accordance with the present invention have a solids content in the range from 10% to 70% by weight, preferably in the range from 30% to 50% by weight.

In one embodiment of the present invention, preferably aqueous formulations in accordance with the present invention have a dynamic viscosity in the range from 50 to 5000 mPa·s, preferably in the range from 100 to 4000 mPa·s and more preferably in the range from 200 to 2000 mPa·s, measured with a Brookfield viscometer to DIN 51562-1 to 4 for example.

In one embodiment of the present invention, preferably aqueous formulations in accordance with the present invention comprise crosslinked organic (co)polymer (b) having a weight average diameter in the range from 10 to 450 nm.

Aqueous formulations in accordance with the present invention make the above-described process of the present invention particularly effective, and are readily processible, for example by dilution with water, into liquors which likewise make the process of the present invention effective.

The present invention further provides a process for producing aqueous formulations that are in accordance with the present invention, hereinafter also referred to as inventive production process. The inventive production process is preferably carried out by mixing
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
(e) if appropriate one or more auxiliaries with water.

The inventive production process can be carried out using any desired vessels, preferably stirred vessels.

The order of adding the components water and
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
(e) if appropriate one or more auxiliaries
   is generally not critical in the practice of the process according to the present invention.

It is preferable if, first, water is introduced as an initial charge and then the components (a) to (c) and if appropriate (d) and (e) are mixed in.

The invention is illustrated by working examples.

The particle diameter distribution of dispersed or emulsified addition copolymers was determined using a Coulter Counter from Malvern in accordance with ISO 13321.

Dynamic viscosities were always determined using a Brookfield viscometer to DIN 51562-1 to 4.

I. Preparation of Components for Inventive Formulations

I.1. Synthesis of Film-Forming Addition Copolymer having NH—CH₂OH Groups, Acetoacetyl Groups or Epoxy Groups

I.1.1 Synthesis of Film-Forming Addition Copolymer having NH—CH₂OH Groups (c.1)

The following mixtures were prepared:

Mixture I.1.1.1:

161 g of completely ion-free water

17.9 g of 28% by weight aqueous solution of n-C₁₂H₂₅(OCH₂CH₂)₃OSO₃Na

163.7 g of n-butyl acrylate, 245.2 g of styrene, 2.8 g of freshly distilled acrylic acid,

12 g of N-methylolmethacrylamide (MAMol) as 15% by weight solution in water.

Mixture I.1.1.2: 0.6 g of Na₂S₂O₈ in 100 ml of completely ion-free water

Mixture I.1.1.3: 0.4 g of HO—CH₂—O—SO₂Na in 50 ml of completely ion-free water

A 5 l tank equipped with stirrer, nitrogen connection and three metering devices was charged with a suspension comprising 160 ml of completely ion-free water and 9.1 g of polystyrene seed (average diameter 30 nm, 33% by weight of suspension in water). Nitrogen was passed through the suspension for one hour. The mixture was then heated to 75° C.

The simultaneous addition was then commenced of mixture I.1.1.1, mixture I.1.1.2 and mixture I.1.1.3. Mixture I.1.1.1 was added within 3 hours, mixture I.1.1.2 and mixture I.1.1.3 within 3 hours 15 minutes. During the addition, the temperature was maintained at 75° C.

Completion of the addition was followed by 30 minutes of stirring at 75° C. and subsequently, for deodorization, by the simultaneous metered addition of a solution of 1.7 g of tert-butyl hydroperoxide (70% by weight in water) in 22 ml of distilled water and of a solution of 0.8 g of HO—CH₂—O—SO₂Na in 25 ml of distilled water over a period of 90 minutes.

This was followed by cooling down to room temperature, addition of a mixture of 0.5 g of 20% by weight solution of 1,2-benzisothiazolin-3-one in propylene glycol and 10 ml of distilled water and subsequent stirring for 10 minutes.

A pH of 6.3 was then set with about 4 g of 25% by weight aqueous ammonia.

The dispersion thus obtainable was subsequently filtered through a 125 μm net. The filtration took 4 minutes. It removed about 2 g of coagulum.

This gave an aqueous dispersion Disp.1, comprising film-forming addition copolymer having NH—CH₂OH groups (c.1). The solids content was 38.7% by weight, the dynamic viscosity was 50 mPa·s. Particle diameter distribution: maximum at 158 nm.

I.1.2. Synthesis of Film-Forming Addition Copolymer having Epoxy Groups (c.2)

The following mixtures were prepared:

Mixture I.1.2.1:

277 g of completely ion-free water

17.9 g of 28% by weight aqueous solution of n-C₁₂H₂₅(OCH₂CH₂)₃OSO₃Na

245.2 g of n-butyl acrylate, 120 g of styrene, 2.8 g of freshly distilled methacrylic acid,

16 g of glycidyl methacrylate, 16 g of 2-hydroxyethyl acrylate.

Mixture I.1.2.2: 4.0 g of Na₂S₂O₈ in 100 ml of completely ion-free water

A 5 l tank equipped with stirrer, nitrogen connection and three metering devices was charged with a suspension comprising 160 ml of completely ion-free water and 9.1 g of polystyrene seed (average diameter 30 nm, 33% by weight suspension in water) and 0.8 g of sodium pyrophosphate. Nitrogen was passed through the suspension for one hour. The mixture was subsequently heated to 75° C.

The simultaneous addition was then commenced of mixture I.1.2.1 and mixture I.1.2.2. Mixture I.1.2.1 was added within 3 hours, mixture I.1.2.2 within 3 hours 15 minutes. The temperature was maintained at 75° C. during the addition.

Completion of the addition was followed by 30 minutes of stirring at 75° C. and subsequently, for deodorization, by the simultaneous metered addition of a solution of 2 g of tert-butyl hydroperoxide (70% by weight in water) in 11 ml of distilled water and of a solution of 2 g of acetone disulfite in 23.5 ml of distilled water over a period of 90 minutes.

This was followed by cooling down to room temperature, addition of a mixture of 0.5 g of 20% by weight solution of 1,2-benzisothiazolin-3-one in propylene glycol and 10 ml of distilled water and subsequent stirring for 10 minutes.

A pH of 5 was then set with about 4 g of 25% by weight aqueous ammonia.

The dispersion thus obtainable was subsequently filtered through a 125 μm net. The filtration took 4 minutes. It removed about 2 g of coagulum.

This gave an aqueous dispersion Disp.2, comprising film-forming addition copolymer having epoxy groups (c.2). The solids content was 39.2% by weight, the dynamic viscosity was 30 mPa·s. Particle diameter distribution: maximum at 157 nm.

I.1.3 Synthesis of Film-Forming Addition Copolymer having NH—CH₂OH Groups (c.3)

The following mixtures were prepared:

Mixture I.1.3.1:

175 g of completely ion-free water

128 g of styrene, 2.8 g of acrylic acid, 12 g of N-methylolmethacrylamide in 68 ml of water,

245.2 g of n-butyl acrylate

8 g of compound VI.1 (see hereinbelow) in 12 ml of water

12 g of N,N-dimethylaminopropylmethacrylamide (DMAPMAM, see hereinbelow)

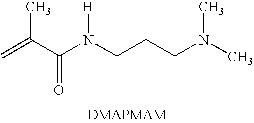

R^{12.1}—[N(CH₂CH₂O)₆H]₂ VI.1

where R^{13.1} is cis(CH₂)₈—CH═CH—(CH₂)₇CH₃, adjusted to pH 4.0 with formic acid.

Mixture I.1.3.2: 2 g of 2,2′-azobis(2-amidinopropane)dihydrochloride in 100 ml of completely ion-free water

A 5 l tank equipped with anchor stirrer, nitrogen connection and three metering devices was charged with an emulsion comprising 250 ml of completely ion-free water, 4 g of compound VI.1 (dissolved in 6 ml of water), 66 g of mixture I.1.3.1 and 10.2 g of mixture I.1.3.2. A pH of 4.0 was set with formic acid. Thereafter, nitrogen was passed through the resulting emulsion for quarter of an hour. The emulsion was subsequently heated to 75° C.

The simultaneous addition was then commenced of the rest of mixture I.1.3.1 and mixture I.1.3.2. The rest of mixture I.1.3.1 was added within 2 hours, the rest of mixture I.1.3.2 within 2 hours 15 minutes. The temperature was maintained at 75° C. during the addition.

Completion of the addition was followed by 30 minutes of stirring at 75° C. and subsequently, for deodorization, by the simultaneous metered addition of a solution of 1.2 g of tert-butyl hydroperoxide (70% by weight in water), diluted with 30 ml of distilled water, and of a solution of 1.2 g of acetone disulfite (13% by weight in water), diluted with 30 ml of distilled water, over a period of 90 minutes.

This was followed by cooling down to room temperature. The dispersion thus obtainable was subsequently filtered through a 125 μm net. The filtration took 4 minutes. It removed about 1 g of coagulum.

This gave an aqueous dispersion Disp.3, comprising film-forming addition copolymer having NH—CH₂OH groups (c.3). The solids content was 37.0% by weight, the dynamic viscosity was 370 mPa·s. Particle diameter distribution: maximum at 100 nm.

I.2 Preparation of Crosslinked Organic Copolymers in Particulate Form (b)

I.2.1. Preparation of Crosslinked Organic Copolymer in Particulate Form (b.1)

The following mixtures were prepared:

Mixture I.2.1.1:

243 g of completely ion-free water

305.2 g of styrene, 2.8 g of acrylic acid,

80 g of allyl methacrylate (see hereinbelow)

8 g of compound VI.1 in 12 ml of water

12 g of N,N-dimethylaminopropylmethacrylamide

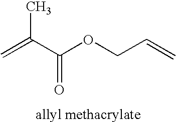

adjusted to pH 4.0 with formic acid.

Mixture I.2.1.2: 2 g of 2,2′-azobis(2-amidinopropane)dihydrochloride in 100 ml of completely ion-free water

A 5 l tank equipped with anchor stirrer, nitrogen connection and three metering devices was charged with an emulsion comprising 250 ml of completely ion-free water, 4 g of compound VI.1 (dissolved in 6 ml of water), 66 g of mixture I.2.1.1 and 10.2 g of mixture I.2.1.2. A pH of 4.0 was set with formic acid. Thereafter, nitrogen was passed through the resulting emulsion for a quarter of an hour. The emulsion was subsequently heated to 75° C.

The simultaneous addition was then commenced of the rest of mixture I.2.1.1 and mixture I.2.1.2. The rest of mixture I.2.1.1 was added within 2 hours, the rest of mixture I.2.1.2 within 2 hours 15 minutes. The temperature was maintained at 75° C. during the addition.

Completion of the addition was followed by 30 minutes of stirring at 75° C. and subsequently, for deodorization, by the simultaneous metered addition of a solution of 1.2 g of tert-butyl hydroperoxide (70% by weight in water), diluted with 30 ml of distilled water, and of a solution of 1.2 g of acetone disulfite (13% by weight in water), diluted with 30 ml of distilled water, over a period of 90 minutes.

This was followed by cooling down to room temperature. The dispersion thus obtainable was subsequently filtered through a 125 μm net. The filtration took 4 minutes. It removed about 0.5 g of coagulum.

This gave an aqueous dispersion WD.1, comprising crosslinked organic copolymer in particulate form (b.1). The solids content was 37.8% by weight, the dynamic viscosity was 35 mPa·s. Particle diameter distribution: maximum at 91 nm.

I.2.2. Preparation of Crosslinked Organic Copolymer in Particulate Form (b.2)

The following mixtures were prepared:

Mixture I.2.2.1:

238 g of completely ion-free water

397 g of styrene

100 g of allyl methacrylate

2.8 g of acrylic acid

28.6 g of 28% by weight aqueous solution of n-C₁₂H₂₅(OCH₂CH₂)₃OSO₃Na

Mixture I.2.2.2: 2 g of Na₂S₂O₈ in 100 ml of completely ion-free water

A 5 l tank equipped with anchor stirrer, nitrogen connection and three metering devices was charged with an emulsion comprising 240 ml of completely ion-free and, 48.5 g of polystyrene seed (average diameter 30 nm, 33% by weight suspension in water). Thereafter, nitrogen was passed through the resulting suspension for a quarter of an hour. The suspension was subsequently heated to 85° C.

The simultaneous addition was then commenced of mixture I.2.2.1 and mixture I.2.2.2. Mixture I.2.2.1 was added within 3 hours, mixture I.2.2.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 1.7 g of tert-butyl hydroperoxide (70% by weight in water), diluted with 30 ml of distilled water, and of a solution of 1.5 g of acetone disulfite (13% by weight in water), diluted with 30 ml of distilled water, over a period of 90 minutes.

This was followed by cooling down to room temperature. The dispersion thus obtainable was subsequently filtered through a 125 μm net. The filtration took 4 minutes. It removed about 2 g of coagulum.

This gave an aqueous dispersion WD.2, comprising crosslinked organic copolymer in particulate form (b.2). The solids content was 37.2% by weight, the pH was 2.0 and the dynamic viscosity was 30 mPa·s. Particle diameter distribution: maximum at 108 nm.

I.2.3. Preparation of Crosslinked Organic Copolymer in Particulate Form (b.3)

The following mixtures were prepared:

Mixture I.2.3.1:

380 g of completely ion-free water

400 g of styrene,

100 g of allyl methacrylate

16.7 g of 3% by weight solution of sodium pyrophosphate in water,

26.8 g of 28% by weight aqueous solution of n-C₁₂H₂₅(OCH₂CH₂)₃OSO₃Na

Mixture I.2.3.2: 5 g of Na₂S₂O₈ in 100 ml of completely ion-free water

A 5 l tank equipped with anchor stirrer, nitrogen connection and three metering devices was charged with an emulsion comprising 250 ml of completely ion-free water, 8.9 g of a 28% by weight aqueous solution of n-C₁₂H₂₅(OCH₂CH₂)₃OSO₃Na, 139 g of mixture I.2.3.1 and 10.5 g of mixture I.2.3.2. Thereafter, nitrogen was passed through the resulting emulsion for a quarter of an hour. The emulsion was subsequently heated to 85° C.

The simultaneous addition was then commenced of the rest of mixture I.2.2.1 and mixture I.2.2.2. The rest of mixture I.2.2.1 was added within 3 hours, the rest of mixture I.2.2.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 2.1 g of tert-butyl hydroperoxide (70% by weight in water), diluted with 30 ml of distilled water, and of a solution of 11.5 g of acetone disulfite (13% by weight in water), diluted with 30 ml of distilled water, over a period of 90 minutes.

This was followed by cooling down to room temperature. A pH of 8.0 was set with 25% by weight aqueous ammonia. The dispersion thus obtainable was subsequently filtered through a 125 μm net. The filtration took 4 minutes. It removed about 2 g of coagulum.

This gave an aqueous dispersion WD.3, comprising crosslinked organic copolymer in particulate form (b.3). The solids content was 38% by weight, the dynamic viscosity was 30 mPa·s. Particle diameter distribution: maximum at 79 nm.

I.2.4. Preparation of Crosslinked Organic Copolymer in Particulate Form (b.4)

I.2.3 was repeated, except only 3.6 g (instead of 8.9 g) of a 28% by weight aqueous solution of n-C₁₂H₂₅(OCH₂CH₂)₃OSO₃Na were placed in the initial charge.

This gave an aqueous dispersion WD.4, comprising crosslinked organic copolymer in particulate form (b.4). The solids content was 37.7% by weight, the dynamic viscosity was 30 mPa·s. Particle diameter distribution: maximum at 122 nm.

I.2.5. Preparation of Crosslinked Organic Copolymer in Particulate Form (b.5)

The following mixtures were prepared:

Mixture I.2.5.1:

313 g of completely ion-free water

470 g of styrene,

42.7 g of a 35% by weight aqueous solution of N-methylolacrylamide,

15 g of 1,4-butanediol diacrylate

16.7 g of 3% by weight solution of sodium pyrophosphate in water,

35.7 g of 28% by weight aqueous solution of n-C₁₂H₂₅(OCH₂CH₂)₃OSO₃Na

Mixture I.2.2.2: 2.5 g of Na₂S₂O₈ in 100 ml of completely ion-free water

A 5 l tank equipped with anchor stirrer, nitrogen connection and three metering devices was charged with a suspension comprising 300 ml of completely ion-free water and 45.5 g of a 33% by weight polystyrene seed (average diameter 30 nm, in water). Nitrogen was then passed through the suspension for quarter of an hour. The suspension was subsequently heated to 85° C.

The simultaneous addition was then commenced of mixture I.2.5.1 and mixture I.2.5.2. Mixture I.2.5.1 was added within 3 hours, mixture I.2.5.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 1.4 g of tert-butyl hydroperoxide (70% by weight in water), diluted with 30 ml of distilled water, and of a solution of 1.5 g of acetone disulfite (13% by weight in water), diluted with 25 ml of distilled water, over a period of 90 minutes.

This was followed by cooling down to room temperature. A pH of 7 was set with 25% by weight aqueous ammonia. The dispersion thus obtainable was subsequently filtered through a 125 μm net. Filtration took 4 minutes. It removed about 2 g of coagulum.

This gave an aqueous dispersion WD.5, comprising crosslinked organic copolymer in particulate form (b.5). The solids content was 37.9% by weight, the dynamic viscosity was 32 mPa·s. Particle diameter distribution: maximum at 117 nm.

I.2.6. Preparation of Crosslinked Organic Copolymer in Particulate Form (b.6)

The following mixtures were prepared:

Mixture I.2.6.1:

334 g of completely ion-free water

400 g of styrene,

100 g of 1,4-butanediol diacrylate

35.7 g of 28% by weight aqueous solution of n-C₁₂H₂₅(OCH₂CH₂)₃OSO₃Na

Mixture I.2.6.2: 2.5 g of Na₂S₂O₈ in 100 ml of completely ion-free water

A 5 l tank equipped with anchor stirrer, nitrogen connection and three metering devices was charged with a suspension comprising 300 ml of completely ion-free water and 60.6 g of a 33% by weight polystyrene seed (average diameter 30 nm, in water). Nitrogen was then passed through the suspension for quarter of an hour. The suspension was subsequently heated to 85° C.

The simultaneous addition was then commenced of mixture I.2.6.1 and mixture I.2.6.2. Mixture I.2.6.1 was added within 3 hours, mixture I.2.6.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 1.4 g of tert-butyl hydroperoxide (70% by weight in water), diluted with 30 ml of distilled water, and of a solution of 1.5 g of acetone disulfite (13% by weight in water), diluted with 25 ml of distilled water, over a period of 90 minutes.

This was followed by cooling down to room temperature. A pH of 7 was set with 25% by weight aqueous ammonia. The dispersion thus obtainable was subsequently filtered through a 125 μm net. Filtration took 4 minutes. It removed about 2 g of coagulum.

This gave an aqueous dispersion WD.6, comprising crosslinked organic copolymer in particulate form (b.6). The solids content was 38% by weight, the dynamic viscosity was 30 mPa·s. Particle diameter distribution: maximum at 111 nm.

I.2.7. Preparation of Crosslinked Organic Copolymer in Particulate Form (b.7)

The following mixtures were prepared:

Mixture I.2.7.1:

238 g of completely ion-free water

377 g of styrene, 2.8 g of acrylic acid,

20 g of 1,4-butanediol diacrylate

28.6 g of 28% by weight aqueous solution of n-C₁₂H₂₅(OCH₂CH₂)₃OSO₃Na

Mixture I.2.7.2: 2.0 g of Na₂S₂O₈ in 100 ml of completely ion-free water

A 5 l tank equipped with anchor stirrer, nitrogen connection and three metering devices was charged with a suspension comprising 300 ml of completely ion-free water and 48.5 g of a 33% by weight polystyrene seed (average diameter 30 nm, in water). Nitrogen was then passed through the suspension for quarter of an hour. The suspension was subsequently heated to 85° C.

The simultaneous addition was then commenced of mixture I.2.7.1 and mixture I.2.7.2. Mixture I.2.7.1 was added within 3 hours, mixture I.2.7.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 1.4 g of tert-butyl hydroperoxide (70% by weight in water), diluted with 30 ml of distilled water, and of a solution of 1.5 g of acetone disulfite (13% by weight in water), diluted with 25 ml of distilled water, over a period of 90 minutes.

This was followed by cooling down to room temperature. The dispersion thus obtainable was subsequently filtered through a 125 μm net. Filtration took 4 minutes. It removed about 2 g of coagulum.

This gave an aqueous dispersion WD.7 having a pH of 2.0, comprising crosslinked organic copolymer in particulate form (b.7). The solids content was 37.4% by weight, the dynamic viscosity was 30 mPa·s. Particle diameter distribution: maximum at 105 nm.

I.2.8. Preparation of Crosslinked Organic Copolymer in Particulate Form (b.8)

I.2.7 was repeated, except that a mixture I.2.8.1 was used, which had the following composition:

238 g of completely ion-free water

377 g of styrene, 2.8 g of acrylic acid,

40 g of 1,4-butanediol diacrylate

28.6 g of 28% by weight aqueous solution of n-C₁₂H₂₅(OCH₂CH₂)₃OSO₃Na.

This gave an aqueous dispersion WD.8 having a pH of 2.0, comprising crosslinked organic copolymer in particulate form (b.8). The solids content was 37.5% by weight, the dynamic viscosity was 30 mPa·s. Particle diameter distribution: maximum at 108 nm.

I.2.9. Preparation of Crosslinked Organic Copolymer in Particulate Form (b.9)

I.2.7 was repeated, except that a mixture I.2.9.1 was used, which had the following composition:

238 g of completely ion-free water

377 g of styrene, 2.8 g of acrylic acid,

60 g of 1,4-butanediol diacrylate

28.6 g of 28% by weight aqueous solution of n-C₁₂H₂₅(OCH₂CH₂)₃OSO₃Na.

This gave an aqueous dispersion WD.9 having a pH of 2.0, comprising crosslinked organic copolymer in particulate form (b.9). The solids content was 37.1% by weight, the dynamic viscosity was 30 mPa·s. Particle diameter distribution: maximum at 108 nm.

I.2.10. Preparation of Crosslinked Organic Copolymer in Particulate Form (b.10)

The following mixtures were prepared:

Mixture I.2.10.1:

311 g of completely ion-free water

450 g of styrene,

10 g of 1,3-divinylbenzene, 25 g of allyl methacrylate

42.9 g of a 35% by weight aqueous solution of N-methylolacrylamide

35.7 g of 28% by weight aqueous solution of n-C₁₂H₂₅(OCH₂CH₂)₃OSO₃Na

Mixture I.2.10.2: 2.5 g of Na₂S₂O₈ in 100 ml of completely ion-free water

A 5 l tank equipped with anchor stirrer, nitrogen connection and three metering devices was charged with a suspension comprising 300 ml of completely ion-free water and 15.2 g of a 33% by weight polystyrene seed (average diameter 30 nm, in water). Nitrogen was then passed through the resulting suspension for quarter of an hour. The suspension was subsequently heated to 85° C.

The simultaneous addition was then commenced of mixture I.2.10.1 and mixture I.2.10.2. Mixture I.2.10.1 was added within 3 hours, mixture I.2.10.2 within 3 hours 15 minutes. The temperature was maintained at 85° C. during the addition.

Completion of the addition was followed by 30 minutes of stirring at 85° C. and subsequently, for deodorization, by the simultaneous metered addition of a solution of 1.4 g of tert-butyl hydroperoxide (70% by weight in water), diluted with 30 ml of distilled water, and of a solution of 1.5 g of acetone disulfite (13% by weight in water), diluted with 25 ml of distilled water, over a period of 90 minutes.

This was followed by cooling down to room temperature. A pH of 7 was set with 25% by weight aqueous ammonia. The dispersion thus obtainable was subsequently filtered through a 125 μm net. Filtration took 4 minutes. It removed about 2 g of coagulum.

This gave an aqueous dispersion WD.10, comprising crosslinked organic copolymer in particulate form (b.10). The solids content was 37.6% by weight, the dynamic viscosity was 32 mPa·s. Particle diameter distribution: maximum at 157 nm.

I.2.11. Preparation of Crosslinked Organic Copolymer in Particulate Form (b.11)

I.2.10 was repeated, except that a mixture I.2.11.1 was used, which had the following composition:

311 g of completely ion-free water

450 g of styrene,

75 g of 1,3-divinylbenzene

42.9 g of a 35% by weight aqueous solution of N-methylolacrylamide

35.7 g of 28% by weight aqueous solution of n-C₁₂H₂₅(OCH₂CH₂)₃OSO₃Na.

This gave an aqueous dispersion WD.11 having a pH of 7.0, comprising crosslinked organic copolymer in particulate form (b.11). The solids content was 37.2% by weight, the dynamic viscosity was 32 mPa·s. Particle diameter distribution: maximum at 117 nm.

I.2.12. Preparation of Crosslinked Organic Copolymer in Particulate Form (b.12)

I.2.8 was repeated, except that a mixture I.2.12.1 was used, which had the following composition:

238 g of completely ion-free water

377 g of styrene, 2.8 g of acrylic acid,

60 g of allyl methacrylate

28.6 g of 28% by weight aqueous solution of n-C₁₂H₂₅(OCH₂CH₂)₃OSO₃Na.

This gave an aqueous dispersion WD.12 having a pH of 2.0, comprising crosslinked organic copolymer in particulate form (b.12). The solids content was 37.2% by weight, the dynamic viscosity was 30 mPa·s. Particle diameter distribution: maximum at 108 nm.

I.2.13. Preparation of Crosslinked Organic Copolymer in Particulate Form (b.13)

The following mixtures were prepared:

Mixture I.2.13.1:

200 g of completely ion-free water

150 g of styrene, 256.6 g of n-butyl acrylate, 3.5 g of acrylic acid

45 g of 1,4-butanediol diacrylate

35.7 g of 28% by weight aqueous solution of n-C₁₂H₂₅(OCH₂CH₂)₃OSO₃Na

Mixture I.2.13.2:

68 g of completely ion-free water

25 g of styrene, 15 g of N-methylolmethacrylamide in 85 ml of water

5 g of 1,4-butanediol diacrylate

7.1 g of 28% by weight aqueous solution of n-C₁₂H₂₅(OCH₂CH₂)₃OSO₃Na

Mixture I.2.13.3: 2.5 g of Na₂S₂O₈ in 100 ml of completely ion-free water

A 5 l tank equipped with anchor stirrer, nitrogen connection and three metering devices was charged with a suspension comprising 300 ml of completely ion-free water and 60.6 g of a 33% by weight polystyrene seed (average diameter 30 nm, in water). Thereafter, nitrogen was passed through the resulting suspension for a quarter of an hour. The suspension was subsequently heated to 85° C.

Thereafter, the simultaneous addition was commenced of mixture I.2.13.1 and mixture I.2.13.3. Mixture I.2.13.1 was added within 2 hours 30 minutes, mixture I.2.13.3 within 3 hours 15 minutes. The temperature was maintained at 85° C. during the addition. Immediately on completion of the addition of mixture I.2.13.1 the addition was commenced of mixture I.2.13.2, which was added within 30 minutes.

Completion of the addition was followed by 30 minutes of stirring at 85° C. and subsequently, for deodorization, by the simultaneous metered addition of a solution of 1.4 g of tert-butyl hydroperoxide (70% by weight in water), diluted with 30 ml of distilled water, and of a solution of 1.5 g of acetone disulfite (13% by weight in water), diluted with 25 ml of distilled water, over a period of 90 minutes.

The batch was subsequently cooled down to room temperature. A pH of 7 was set with 25% by weight aqueous ammonia. The dispersion thus obtainable was subsequently filtered through a 125 μm net. The filtration took 4 minutes. It removed about 2 g of coagulum.

This gave an aqueous dispersion WD.13, comprising crosslinked organic copolymer in particulate form (b.13). The solids content was 37.7% by weight, the dynamic viscosity was 32 mPa·s. Particle diameter distribution: maximum at 101 nm.

I.2.14. Preparation of Crosslinked Organic Copolymer in Particulate Form (b.14)

The following mixtures were prepared:

Mixture I.2.14.1:

209 g of completely ion-free water

178.6 g of methyl methacrylate, 141.7 g of n-butyl acrylate, 8 g of methacrylic acid

60 g of 1,4-butanediol diacrylate

1.5 g of n-C₁₆H₃₃O(CH₂CH₂O)₇H in 2.3 ml of water

Mixture I.2.14.2: 2.4 g of Na₂S₂O₈ in 31 ml of completely ion-free water

A 5 l tank equipped with anchor stirrer, nitrogen connection and three metering devices was charged with an emulsion comprising 468 ml of completely ion-free water, 1.8 g of a 33% by weight polystyrene seed (average diameter 30 nm, in water), 5.3 g of n-butyl acrylate and 6.5 g of methyl methacrylate. Thereafter, nitrogen was passed through the resulting emulsion for a quarter of an hour. The emulsion was subsequently heated to 85° C. and 3.4 g of mixture I.2.14.2 were added. Stirring was carried out for a further 15 minutes at 85° C.

Thereafter, the simultaneous addition was commenced of mixture I.2.14.1 and the rest of mixture I.2.14.2. Mixture I.2.14.1 was added within 2 hours, the rest of mixture I.2.14.2 within 2 hours 15 minutes. The temperature was maintained at 85° C. during the addition.

Completion of the addition was followed by 30 minutes of stirring at 85° C. and subsequently, for deodorization, by the simultaneous metered addition of a solution of 0.4 g of tert-butyl hydroperoxide dissolved in 3.6 ml of distilled water, and of a solution of 0.7 g of acetone disulfite (13% by weight in water) over a period of 60 minutes.

This was followed by cooling down to room temperature and adding 2.4 g of a 25% by weight aqueous ammonia solution. The dispersion thus obtainable was subsequently filtered through a 125 μm net. The filtration took 4 minutes. It removed about 2 g of coagulum.

This gave an aqueous dispersion WD.14 having a pH of 9.2, comprising crosslinked organic copolymer in particulate form (b.14). The solids content was 34% by weight, the dynamic viscosity was 30 mPa·s. Particle diameter distribution: maximum at 252 nm.

I.3 Production of Inventive Aqueous Formulations

The following ingredients were used:

Random copolymer of Mn 30 000 g/mol (GPC) from 10% by weight of methacrylic acid and 90% by weight of CH₂═CHCOO—CH₂—CH₂—O-n-C₆F₁₃ in aqueous dispersion (20% by weight solids content) (a1.1),

paraffin wax (unbranched, melting range 65-70° C., average number of carbon atoms per molecule: 40) (a2.1)

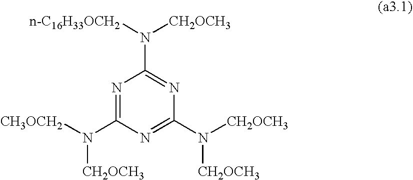

(d.1): reaction product of oleylamine with 6 equivalents of ethylene oxide

(e.1): white oil,

(e.2): compound of formula

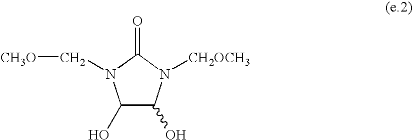

The components of Table 1 were mixed in a stirred vessel and made up with water to 1 liter if appropriate to obtain the inventive aqueous formulations F.1 to F.3.

The particles of (b) in the inventive aqueous formulations F.1 to F.3 did not tend to agglomerate.

(c. 1) was added in the form of Disp. 1, (b.1) in the form of WD. 1 and so on. For each the amounts of solids are reported in the table.

TABLE 1
Compositions of inventive aqueous formulations

| Number | (a) | (b) | (c) | (d) | (e) |
|---|---|---|---|---|---|
| F.1 | 70.9 g (a1.1) | 106.3 g (b.1) | 70.9 g (c.3) | * | — |
| F.2 | 114.5 g (a2.1), | 44 g (b.1) | 46.5 g (c.3) | *, 7.5 g (d.1) | 13 g (e.1), |
| | 48 g (a3.1) | | | | 199.7 g (e.2) |
| F.3 | 70.9 g (a1.1) | 106.3 g (b.3) | 70.9 g (c.1) | ** | — |

*Compound VI.1 from the preparation of (b.1), n-C₁₂H₂₅(OCH₂CH₂)₃OSO₃Na from the preparation of (c.3)
** n-C₁₂H₂₅(OCH₂CH₂)₃OSO₃Na from the preparation of (b.3) and (c.1)

I.4 Preparation of an Anionic Primer (f_{A}.1)

The following mixtures were prepared:

Mixture I.4.1:

146 g of completely ion-free water

130.8 g of styrene, 245.2 g of n-butyl acrylate, 12 g of acrylic acid,

17.9 g of 28% by weight aqueous solution of n-C₁₂H₂₅(OCH₂CH₂)₃OSO₃Na

12 g of N-methylolmethacrylamide dissolved in 68 g of water,

Mixture I.4.2: 0.6 g of Na₂S₂O₈ in 100 ml of completely ion-free water

Mixture I.4.3: 0.4 g of HO—CH₂SO₂Na in 100 ml of completely ion-free water

A 5 l tank equipped with stirrer, nitrogen connection and three metering devices was charged with a suspension comprising 160 ml of completely ion-free water and 9.1 g of a 33% by weight polystyrene seed (average diameter 30 nm, in water). Nitrogen was passed through the suspension for an hour. The suspension was then heated to 75° C.

Thereafter, the simultaneous addition was commenced of mixtures I.4.1, I.4.2 and I.4.3. Mixture I.4.1 was added within 3 hours, mixtures I.4.2 and I.4.3 each within 3 hours 15 minutes. The temperature was maintained at 75° C. during the addition.

Completion of the addition was followed by 30 minutes of stirring at 75° C. and subsequently, for deodorization, by the simultaneous metered addition of a solution of 1.2 g of tert-butyl hydroperoxide (70% by weight in water), diluted with 22 ml of distilled water, and of a solution of 0.8 g of HO—CH₂SO₂Na, diluted with 25 ml of distilled water, over a period of 90 minutes.

The batch was subsequently cooled down to room temperature and adjusted to pH 7.5 with 25% by weight aqueous ammonia. The dispersion thus obtainable was subsequently filtered through a 125 μm net. The filtration took 4 minutes. It removed about 1 g of coagulum.

This gave primer (f_{A}.1) in aqueous dispersion with a pH of 7.5. The solids content was 39.6% by weight, the dynamic viscosity was 310 mPa·s. Particle diameter distribution: maximum at 216 nm.

A reaction product of equimolar amounts of piperazine with epichlorohydrin and benzyl chloride was used as cationic primer (f_{K}.1), molecular weight M_{w} 15 000 g/mol.

II. Inventive Treatment of Textile Surfaces

The following textiles were used:

Cotton: 1 m 30 cm, 100% woven cotton, bleached, nonmercerized, twill construction, basis weight 196 g/m² (Co)

Polyester: 1 m 30 cm, woven polyester staple fiber, basis weight 220 g/m² (PES)

The following equipment was used in all cases:

Pad-mangle: manufactured by Mathis, model HVF12085, contact pressure 1-3 bar. The contact pressure setting in all cases was such that the wet pickup (based on weight of fiber) was 60% in the case of polyester and 90% in the case of cotton, unless otherwise stated. The liquor was at room temperature, unless otherwise stated.

Dryer: continuous dryer from Mathis THN 12589

Test methods:

Spray test: AATCC 22-2001, Oil rating: AATCC 118-2002,

Hydrophobicization: AATCC 193-2004, Smoothness: AATCC 124-2001

Wash conditions: delicates cycle at 30° C., 15 g/l of a mild laundry detergent,

Washing machine: Miele Novotronic T440C, Setting: tumbler dry, hand iron moist.

II.1 Inventive Treatment of Textile Surfaces in Two or More Stages—Production of Co.1 and PES.1

General Working Prescription:

Textile (Co or PES) was padded with an aqueous liquor according to Table 2 (step 1). This was followed by drying on a tenter at 110° C. for two minutes and subsequent padding with a liquor according to Table 2 (step 2). Thereafter, the textile thus treated was treated in a dryer at 160° C. for 2 minutes. This gave inventive textile according to Table 2.

The aqueous liquors were produced by mixing (diluting) the Table 2 components with water to one liter.

A hydrophilicized isocyanurate/diisocyanate from Example 4 of EP 0 486 881 was used as auxiliary (e.4).

### II.2 Inventive Treatment of Primered Textile Surfaces in Two or More Stages—Production of PES.2

PES was initially padded with an aqueous liquor comprising 8.3 g/l of cationic primer (f_{K}.1). The wet pickup was 60%, the add-on 0.5 g of (f_{K}.1)/m² of PES. This was followed by thermal treatment at 120° C. in a dryer for 2 minutes.

This was followed by padding with an aqueous liquor according to Table 2 (step 1). This was followed by drying on a tenter at 110° C. for two minutes to a residual moisture content of 6% by weight and subsequent padding with a liquor according to Table 2 (step 2). Thereafter, the textile thus treated was treated in a dryer at 160° C. for 2 minutes. This gave inventive textile according to Table 2.

The aqueous liquors were produced by mixing (diluting) the Table 2 inventive formulations with water to one liter.

A hydrophilicized isocyanurate/diisocyanate from Example 4 of EP 0 486 881 was used as auxiliary (e.4).

II.3 Inventive Treatment of Textile Surfaces in One Stage—Production of Co.2 and Co.7

Co was padded with an aqueous liquor according to Table 2. This was followed by drying on a tenter at 110° C. for 2 minutes to a residual moisture content of 7% and a subsequent thermal treatment at 160° C. in a dryer for 2 minutes. This gave inventive textile Co.2 or Co.7 according to Table 2.

To produce inventive Co.3 and Co.7, the procedure according to Table 2 was repeated, except that the starting material used was 1 m 30 cm, 100% woven cotton, bleached, nonmercerized, twill construction, basis weight 120 g/m², and the thermal treatment was carried out at 150° C. (instead of 160° C.). This gave inventive textile Co.3 or Co.7. The spray test result was 90, the smoothness result was DP 3.25 (for Co.3) and 3.5 (for Co.7).

II.4 Inventive Treatment of Primered Textile Surfaces in Two or More Stages—Production of PES.3

PES was initially padded with an aqueous liquor comprising 8.3 g/l of anionic primer (f_{A}.1). The wet pickup was 60%, the add-on was 0.5 g of (f_{A}.1)/m² of PES. This was followed by thermal treatment at 120° C. in a dryer for 2 minutes.

This was followed by padding with an aqueous liquor according to Table 2 (step 1). This was followed by drying on a tenter at 110° C. for two minutes to a residual moisture content of 6% by weight and subsequent treatment at 160° C. in a dryer for 2 minutes. This gave inventive textile PES.3 according to Table 2.

The aqueous liquors were produced by mixing (diluting) the Table 2 inventive formulations with water to one liter.

### II.5 Inventive Treatment of Textile Surfaces in Two or More Stages—Production of Co.4 and PES.4

Co was padded with an aqueous liquor according to Table 2 (step 1). This was followed by drying on a tenter at 110° C. for two minutes and subsequent padding with a liquor according to Table 2 (step 2). Thereafter, the textile thus treated was treated in a dryer at 160° C. for 2 minutes. This gave inventive textile Co.4 according to Table 2.

The aqueous liquors were produced by mixing (diluting) the Table 2 components with water to one liter.

### II.6 Inventive Treatment of Primered Textile Surfaces in Two or More Stages—Production of Co.5 and Co.6

Co was initially padded with an aqueous liquor comprising 5 g/l of cationic primer (f_{K}.1). The wet pickup was 90%, the add-on was 0.5 g of (f_{K}.1)/m² of PES. This was followed by thermal treatment at 140° C. in a dryer for 2 minutes. This was followed by padding with an aqueous liquor according to Table 2 (step 1). This was followed by drying on a tenter at 110° C. for two minutes and subsequent padding with a liquor according to Table 2 (step 2). Thereafter, the textile thus treated was treated in a dryer at 160° C. for 2 minutes. This gave inventive textile Co.5 or Co.6 according to Table 2.

The aqueous liquors were produced by mixing (diluting) the Table 2 components with water to one liter.

A hydrophilicized isocyanurate/diisocyanate from Example 4 of EP 0 486 881 was used as auxiliary (e.4).

TABLE 2
Inventive treatment of textile

| | | | Dyn. roll-off | Oil | | Oil rating/ | | Add-on | Add-on | Add-on |
|---|---|---|---|---|---|---|---|---|---|---|
| No. | Stage 1 | Stage 2 | angle [°] | rating | Hydroph. | 10 | Hydroph./10 | (a) [g/m²] | (b) [g/m²] | (c) [g/m²] |
| Co.1 | 21.3 g WD.1, | 5.7 g/l (a1.1) | 9 | 7 | 9 | 6 | 8 | 1.0 | 1.5 | 1.0 |
| | 14.9 g Disp.3 | | | | | | | | | |
| PES.1 | 28.4 g WD.1 | 5.7 g/l (a1.1) | n.d. | 5 | 8 | 4 | 7 | 1.0 | 1.5 | 1.0 |
| | 19.9 g Disp.3 | | | | | | | | | |
| PES.2 | 28.4 g WD.1 | 5.7 g/l (a1.1) | 11 | 7 | 10 | 7 | 9 | 1.0 | 1.5 | 1.0 |
| | 19.9 g Disp.3 | | | | | | | | | |
| Co.2 | 80 g/l F.1 | — | 14 | 6 | 9 | 4 | 7 | n.d. | n.d. | n.d. |
| Co.3 | 200 g/l F.2, 8 g/l | — | 15 | n.d. | n.d. | n.d. | n.d. | n.d. | n.d. | n.d. |
| | Zn(NO₃)₂, | | | | | | | | | |
| | 0.7 g/l (e.4) | | | | | | | | | |
| PES.3 | 110 g/l F.3 | — | 12 | 7 | 9 | 6 | 8 | n.d. | n.d. | n.d. |
| Co.4 | 21.3 g WD.3, | 5.7 g/l (a1.1) | 22 | n.d. | n.d. | nd. | n.d. | 1.0 | 1.5 | 1.0 |
| | 14.9 g Disp.1 | | | | | | | | | |
| PES.4 | 28.4 g WD.3 | 7.6 g/l (a1.1) | 13 | 7 | 10 | 7 | 8 | 1.0 | 1.5 | 1.0 |
| | 19.9 g Disp.1 | | | | | | | | | |
| Co.5 | 21.3 g WD.3, | 5.7 g/l (a1.1) | 10 | 7 | 10 | 6 | 10 | 1.0 | 1.5 | 1.0 |
| | 14.9 g Disp.1 | | | | | | | | | |
| Co.6 | 21.3 g WD.3, | 5.7 g/l (a1.1) | 11 | 7 | 10 | 7 | 9 | 1.0 | 1.5 | 1.0 |
| | 14.9 g Disp.2 | | | | | | | | | |
| Co.7 | 200 g/l F.2, 8 g/l | — | 15 | n.d. | n.d. | n.d. | n.d. | n.d. | n.d. | |
| | Zn(NO₃)₂, | | | | | | | | | |
| | 0.7 g/l (e.4) | | | | | | | | | |

Abbreviations:
n.d.: not determined.
Hydroph.: hydrophobicization
Oil rating/10: oil rating after 10 domestic washes
Hydroph./10: hydrophobicization after 10 domestic washes
Inventive textiles Co.1 to Co.7 were also easy iron.

We claim:

1. A process for treating a surface, which comprises said surface being treated with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
and subsequently dried.

2. The process according to claim 1 wherein said surface is a textile surface.

3. The process according to claim 1 or 2 wherein said crosslinked organic copolymer (b) has a weight average diameter in the range from 10 to 450 nm.

4. The process according to any one of claims 1 to 3 wherein said surface is treated at a temperature in the range from 120 to 180° C. after drying.

5. The process according to any one of claims 1 to 4 wherein said at least one hydrophobicizing agent (a) is selected from
(a1) halous organic (co)polymers,
(a2) paraffins, and
(a3) compounds having at least one C₁₀-C₆₀-alkyl group per molecule.

6. The process according to any one of claims 1 to 5 wherein said surface is treated with an aqueous formulation comprising
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers.

7. The process according to any one of claims 1 to 6 wherein said treating is effected in the presence of one or more auxiliaries (e).

8. The process according to any one of claims 1 to 7 wherein said treating with
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers
(e) if appropriate one or more auxiliaries is preceded by the application of a primer (f).

9. A surface coated with
(a) if appropriate a primer,
(b) at least one hydrophobicizing agent,
(c) at least one crosslinked organic copolymer in particulate form,
(d) at least one film-forming addition copolymer having epoxy groups, NH—CH₂OH groups or acetoacetyl groups.

10. The surface according to claim 9 wherein said coating has an average add-on in the range from 0.2 to 10 g/m².

11. The surface according to claim 9 or 10 comprising a textile surface.

12. The surface according to any one of claims 9 to 11 wherein said crosslinked organic (co)polymer (b) has a weight average diameter in the range from 10 to 450 nm.

13. The surface according to any one of claims 9 to 12 wherein said at least one hydrophobicizing agent (a) is selected from
(a1) halous organic (co)polymers,
(a2) paraffins, and
(a3) compounds having at least one C₁₀-C₆₀-alkyl group per molecule.

14. An aqueous formulation comprising
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
(e) if appropriate one or more auxiliaries.

15. The aqueous formulation according to claim 14 wherein said crosslinked organic (co)polymer (b) has a weight average diameter in the range from 10 to 450 nm.

16. The aqueous formulation according to claim 14 or 15 wherein said at least one hydrophobicizing agent (a) is selected from
(a1) halous organic (co)polymers,
(a2) paraffins, and
(a3) compounds having at least one C₁₀-C₆₀-alkyl group per molecule.

17. A process for producing an aqueous formulation according to any one of claims 14 to 16, which comprises mixing
(a) at least one hydrophobicizing agent,
(b) at least one crosslinked organic copolymer in particulate form,
(c) at least one film-forming addition copolymer having epoxy groups, NH—CH₂OH groups or acetoacetyl groups,
(d) if appropriate one or more emulsifiers,
(e) if appropriate one or more auxiliaries with water.
